(19) United States
(12) Patent Application Publication
(10) Pub. No.: US 2016/0084454 A1
(43) Pub. Date: Mar. 24, 2016

(54) STORAGE ENCLOSURE

(71) Applicants: Timothy Paul Svitak, SR., Marlton, NJ (US); Timothy Paul Svitak, JR., West Chester, PA (US)

(72) Inventors: Timothy Paul Svitak, SR., Marlton, NJ (US); Timothy Paul Svitak, JR., West Chester, PA (US)

(21) Appl. No.: 14/858,999

(22) Filed: Sep. 18, 2015

Related U.S. Application Data
(60) Provisional application No. 62/052,687, filed on Sep. 19, 2014.

(51) Int. Cl. F21L 4/08; B65D 55/02; F21V 33/00; B65D 25/20; B65D 81/02; B65D 43/16; B65D 25/14

(52) U.S. Cl. CPC F21L 4/08; B65D 43/16; B65D 55/02; B65D 25/14; B65D 25/20; B65D 81/02; F21V 33/0004; F21Y 2101/02

(57) ABSTRACT

A storage enclosure includes a first portion with a recessed inner surface, a complementary second portion with a recessed inner surface coupled to the first portion, where a first end of the second portion is hinged to a first end of the first portion and where a resealable opening extends along a second end of the second portion and a second end of the first portion. A solar panel is mounted to an outer surface of the first portion, a charging panel within the storage enclosure, where the charging panel is mounted to the inner recessed surface of the second portion and is electrically connected to the solar panel and an internal battery, and a light is mounted to the outer surface of the second portion and electrically connected to the charging port.

### TECHNICAL FIELD

This specification generally relates to containers, in particular a storage enclosure.

### BACKGROUND

Outdoor activities may be fun, but extended periods outdoors often leave people in need of a place to charge their electronic devices. For example, people who may be hiking, fishing, kayaking, boating, or camping often need to keep their electronic devices charged while having their devices in a dry safe place.

### SUMMARY

In a general aspect, a storage enclosure includes a first portion with a recessed inner surface, a complementary second portion with a recessed inner surface, coupled to the first portion where a first end of the second portion is hinged to a first end of the first portion and where a resealable opening extends along a second end of the second portion and a second end of the first portion, a solar panel mounted to an outer surface of the first portion, a charging panel within the storage enclosure, where the charging panel is mounted to the inner recessed surface of the second portion, and is electrically connected to the solar panel and an internal battery and a light mounted on an outer surface of the second portion and electrically connected to the charging panel.

Implementations of this aspect may include one or more of the following features. For example, the light is an LED light. The light is a water activated strobe light. The strobe light emits a distress signal when activated. Implementations of this aspect may include one or more of the following features. For example, the storage enclosure is water-proof. The storage enclosure is shock-proof. The storage enclosure is dust-proof. The storage enclosure is fire-proof.

Implementations of this aspect may include one or more of the following features. For example, the resealable opening is held in a closed position by a locking mechanism. A second solar panel is mounted to the outer surface of the second portion. The charging panel includes one or more USB charging ports. The inner recessed surface of the second portion is lined with a charging pad. The inner recessed surfaces of the first and second portions are lined with silicone. The charging panel includes an LCD screen that indicates a level of battery power.

Implementations of this aspect include one or more of the following features. For example, the storage enclosure includes a connector that connects to a harness clip. The storage enclosure is sized to store a tool kit. The inner recessed surface of the first portion includes one or more Velcro® straps. The inner recessed surface of the first portion includes a removable netting.

### DESCRIPTION OF DRAWINGS

FIG. 1 shows a storage enclosure in a closed position.

FIG. 2 shows the charging panel within the storage enclosure.

FIG. 3 shows the storage enclosure in an opened position.

FIG. 4 shows an electronic device stored within the storage enclosure.

FIG. 5 shows a storage enclosure with a patterned solar panel.

FIG. 6 shows the inner surfaces of a storage enclosure and a removable netting.

FIG. 7 shows the position of the netting in the storage enclosure.

### DETAILED DESCRIPTION

The present invention is directed to a storage enclosure that can be used to store and charge electronic devices. A user may charge the storage enclosure by connecting the storage enclosure to a power outlet when one is available. The charge stored at the internal battery of the storage enclosure may be used to charge electronic devices when a power source is not available, for example when a user is in a remote area camping, fishing, hiking, or participating in any other outdoor activity. In some embodiments the storage enclosure may include a solar panel on the outer surface of the enclosure. The solar panel may be used to charge the internal battery of the storage enclosure when the user is outdoors and/or away from a power source. The solar panel can also act as a backup power supply when the internal battery is low on power.

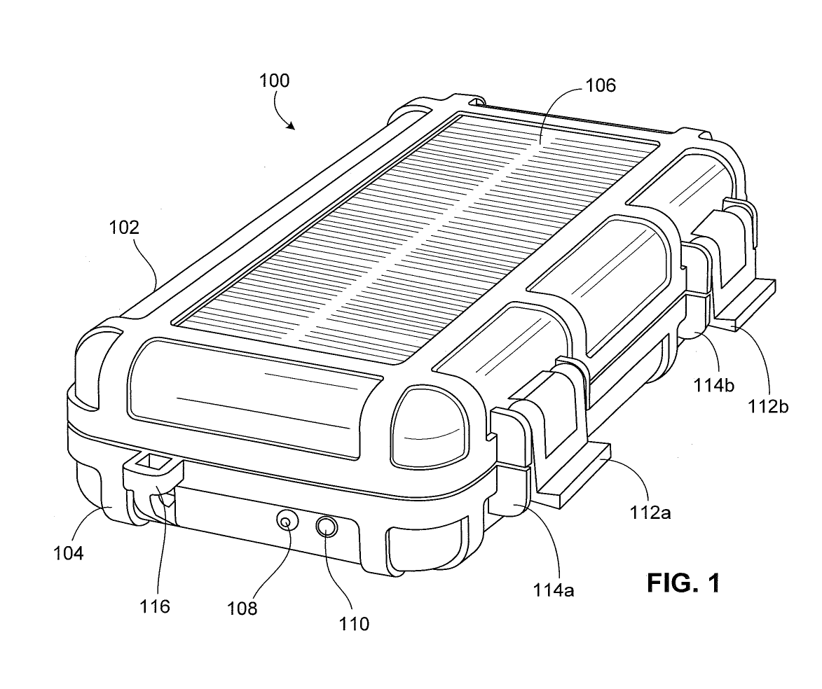

As illustrated in FIG. 1, the storage enclosure 100 is rectangular shaped. In some implementations, the storage enclosure 100 may have external dimensions of 9.6 inches by 5 inches by 2.8 inches, with internal dimensions of 56.7 cubic inches. The storage enclosure includes an upper portion 102 and a lower portion 104. The upper portion 102 and the lower portion 104 may be made from a polycarbonate (PC) material. The polycarbonate material may be an injection molded polycarbonate material. The polycarbonate material ensures that the storage enclosure 100 is durable, shock-proof and fairly light weight. In some examples, the storage enclosure may weigh less than two pounds, for example, 1.75 lbs. In some implementations, the upper portion 102 and lower portion 104 may be made from a carbon nanotube material, a polyester material, a high-density polyethylene (HDPE) material, or an acrylic material. In some implementations, the upper portion 102 and lower portion 104 are made from the same material. In some examples, the storage enclosure 100 may be a floatable enclosure. The storage enclosure may be waterproof, dust proof, or drop proof, as well as combinations thereof. In some implementations, the storage enclosure does not block or interrupt any cellular or other electronic signals, and allows any electronic device that is placed in the enclosure to continue receiving phone calls, text messages, emails, or any other type of communication.

In some implementations, the storage enclosure may act as a transceiver. In some implementations, the storage enclosure may include an antenna which may be mounted to a surface of the storage enclosure. The antenna may allow the storage enclosure to communicate through radio signals with other devices with radio communication capability. For example, a user may use the storage enclosure as a walkie-talkie device to communicate with users of other similarly equipped storage enclosure users or with others with appropriate communications devices. In some implementations, the storage enclosure may be made from a material that blocks cellular signals and other electrical signals. For example, a user may want to experience an outdoor event in isolation and may place his or her smart phone in the storage enclosure. The storage enclosure may block the smart phone from receiving any emails, phone calls or text messages that may be sent to the user.

The upper portion 102 of the storage enclosure 100 includes a solar panel 106. The solar panel 106 extends along the outer surface of the upper portion 102. In some implementations, the solar panel may be made from a monocrystalline material. The upper portion 102 further includes two fastening mechanisms 112a and 112b. The lower portion 104 is complementary in shape to the upper portion 102. The lower portion 104 includes two receiver portions 114a and 114b for the fastening mechanisms 112a and 112b. The lower portion 104 also includes a connector 116, an LED light 108 and an on/off knob 110 for the LED light 108. In some implementations, the fastening mechanisms 112a and 112b may be hinges made from stainless steel.

The solar panel 106 on the upper portion 102 may be covered with a clear protective coating. The protective coating may be made from a resilient material such as polycarbonate. The protective coating may help prevent the solar panel from being damaged. For example, the protective coating may prevent the solar panel from water damage. In some implementations, the upper portion 102 may be covered with a clear acrylic coating, or a clear Pyrex glass coating. The protective coating may be an anti-scratch protective coating. In some implementations, the lower portion 104 of the storage enclosure 100 may also include a solar panel. In some implementations, the outer surfaces of both the upper portion 102 and the lower portion 104 may be completely or partially covered with one or more solar panels. In some implementations, the increased surface area covered with the solar panel may increase the rate of charging the internal battery of the storage enclosure.

The light 108 is a high power bright light LED that, when switched on using the on/off knob 110, can be used as a flashlight to illuminate a dark area. The LED light is waterproof on the exterior and it can illuminate for more than two weeks on a fully charged internal battery. In some examples, the LED may be one or more bright white LEDs. In some implementations, the storage enclosure may include two or more internal batteries that can illuminate the LED light. When fully charged, the two or more batteries can illuminate the light for an extended period of time, for example, for more than a week, more than two weeks, or more than four weeks. In some implementations the two or more batteries that illuminate the LED light may be lithium-ion polymer batteries. In some implementations a user may use the LED light as a flashlight while camping. The LED light may have one or more different function settings. In some implementations the LED light may have a low setting, a high setting, a strobe light setting, and an SOS setting. In some implementations, the storage enclosure may have an LED light mounted on the charging panel. The LED light may have an on/off knob on the charging panel. A user may switch the LED on to illuminate the inside of the storage enclosure to view the contents of the enclosure while in a dark area. In some implementations, an LED may be mounted to the inner recessed surface of the first portion.

In some implementations, the LED light may generate a visual SOS signal. In these implementations, the user may tap on the on/off knob 110 once to generate a light, and may tap on the on/off knob twice to generate the visual SOS signal. For example, a user may tap on the on/off knob to signal distress if lost while hunting. In some further implementations, an SOS signal may be generated when the storage container 100 is immersed in water. In these implementations, the LED may detect whether the storage enclosure has been immersed for a predetermined time. For example, the visual SOS signal may be generated by the LED if the storage enclosure falls overboard when used on a boat. The SOS signal may be generated if the boat turns over and the storage container is immersed in the water. The SOS signal may be used to attract rescue personnel to the site of the boat. In some implementations, the storage enclosure is made from a light material that allows the storage enclosure to float when in a closed position. For example, the storage enclosure may be made from a low-density plastic material.

In some implementations, the storage enclosure may be made from a fire resistant material. In these implementations, the storage enclosure may be used to store important documents, for example, identification and cash, while the user is outdoors. For example, while camping, a user may store important documents in the fire-resistant enclosure to protect the documents from fire damage. In some implementations, the storage enclosure may be made of polycarbonate. In some implementations, the storage enclosure may be made of a carbon foam material.

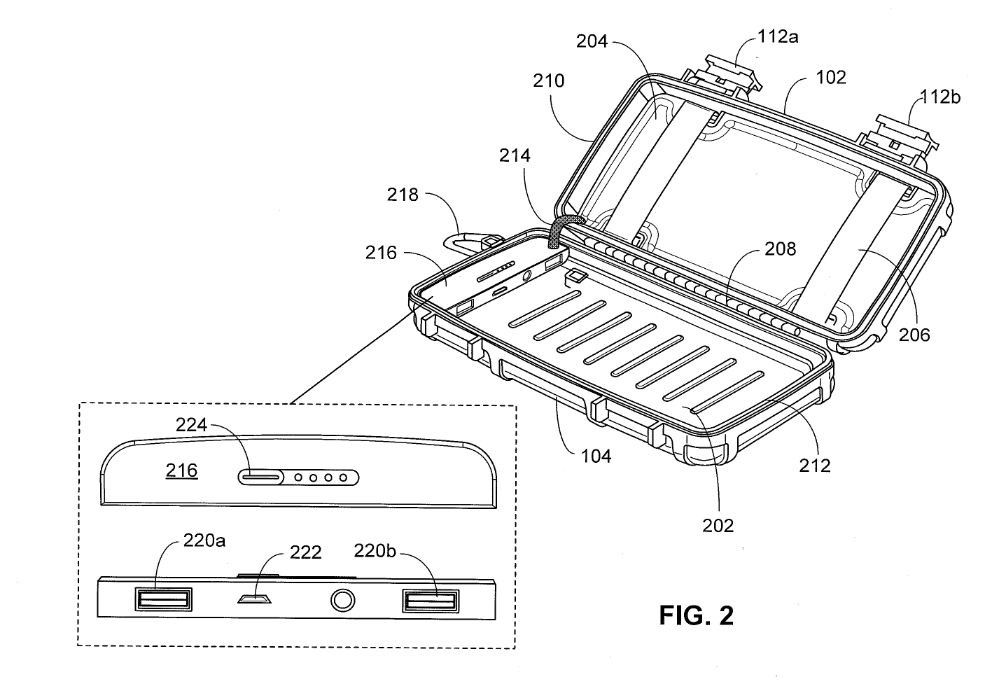

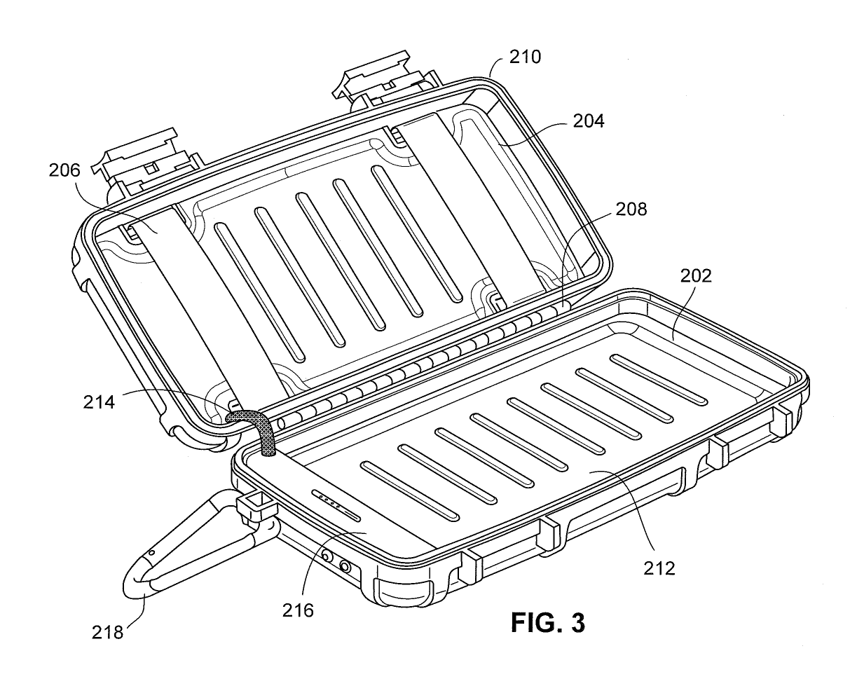

Referring to FIGS. 2 and 3, the storage enclosure includes an upper portion 102 and a lower portion 104. The upper portion 102 and the lower portion 104 are connected to each other by a hinge 208. The hinge 208 runs along a long side of the upper portion 102 and the lower portion 104 of the storage enclosure. The hinge 208 may be made from steel or any other suitable material. The hinge 208 allows for the opening and closing of the storage enclosure. In some implementations, the hinge 208 may be a butterfly hinge or a barrel hinge. The upper portion 102 may include an O-ring 210 that is incorporated along the edge of the upper portion. The O-ring may be made of an elastomer material or any other suitable material. When the storage enclosure is in a closed position, the O-ring 210 aligns with a raised edge 212 of the lower portion 104 and the raised edge 212 compresses the O-ring 210. The compression of the O-ring 210 forms an air tight seal that is impenetrable to air, water and dust. In some implementations, the storage enclosure may be sealed with a fiber washer gasket, a paper gasket, or a cylinder head gasket.

The upper portion 102 of the storage enclosure includes two fastening mechanisms 112a and 112b. The two fastening mechanisms are spaced apart from each other along a long side of the upper portion 102. The fastening mechanisms are positioned on the long side of the upper portion opposite to the long side that is hinged to the lower portion 104. When the storage enclosure is in a closed position, the fastening mechanisms 112a and 112b align with the receiver portions 114a and 114b on the lower portion 104. A user may snap the fastening mechanisms 112a and 112b into the complementary receiver portions 114a and 114b. The fastening mechanisms hold the storage enclosure in a closed position and maintains the seal created by the compressed O-ring. The air tight seal allows the storage enclosure to be water-proof when in a closed position.

In some implementations, the storage enclosure may include one fastening mechanism on the upper portion and one receiver on the lower portion. In these implementations, the fastening mechanism and receiver may be located at a midpoint along the long side of the upper and lower portions. In some implementations, the storage enclosure may include three or more fastening mechanisms spaced along the long side of the upper portion. In some implementations, the upper portion and lower portion of the storage enclosure may not be hinged together at one side but instead the upper portion can be completely separated from the lower portion. In some implementations, the upper portion of the enclosure may have two fasteners positioned on both long sides of the upper portion and two receivers positioned on both long sides of the lower portion. In some implementations, the fastening mechanisms may include a locking feature.

The inner surfaces 204 and 202 of the top portion 102 and the bottom portion 104 are recessed to form areas that can be used to store items. For example, a user can store small electronic items such as an iPod, smart phone, or may store personal documents such as, an identification card, or a passport. In some implementations, the storage enclosure may be a rectangular enclosure that measures about 9×4 inches. In some implementations, the shape and size of the enclosure may vary. The storage enclosure may generally be of any shape, including, without limitation, cylindrical, cuboid or circular. The recessed area 204 of the upper portion 102 and 202 of the lower portion 104 is each lined with a silicone tray. The silicone tray may be textured to prevent items stored in the storage enclosure from moving around. The silicone tray may be soft to protect electronic devices stored within the enclosure from damage. In some implementations, the silicone trays may be removable. In some implementations, the recessed area of both the upper portion and the lower portion are each lined with a polymer material. The inner surface 204 of the upper portion 102 includes two Velcro® straps 206. The straps 206 may be used to hold items stored in the storage enclosure in place. In some implementations, the inner surface 202 of the lower portion 104 may also include Velcro® straps.

The storage enclosure includes one or more internal batteries (not shown) that is located under the silicone tray in the lower portion 104. The one or more batteries store energy that can be used to charge electronic devices that are connected to the storage enclosure. The battery may also store the energy absorbed by the solar panel on the outer surface of the upper portion of the storage enclosure. In some implementations the energy absorbed by the solar panel is transferred to the battery via the plastic optical fiber 214. The battery also stores energy that is received through connecting the storage enclosure to a power source, such as, a wall outlet. While in some implementations the battery is a LiMH battery and can store 12,000 mAh of electric charge, other types of batteries are also suitable for use. For example, in some implementations, the battery is a Nickel Cadmium (Ni—Cd) battery or a Nickel Metal Hydride battery (Ni-MH). In some implementations, the one or more internal batteries may have an operating temperature range of −4° F. to 176° F.

As illustrated in FIG. 2, the lower portion 104 of the storage enclosure includes a charging panel 216. The charging panel 216 is positioned at one end of the recessed inner surface of the lower portion 104. The charging panel 216 may be coated with a nano-coating to prevent the corrosion of the charging ports or to prevent physical damage to the components. The charging panel 216 includes two USB ports 220a and 220b and an inlet charging port 222. The inlet charging port 222 is used to charge the internal battery by connecting one end of a power cord to the inlet and the other end to a wall outlet or car charger, or any other suitable power source. In some implementations, the internal battery may be fully charged via the USB port within six hours. In some implementations, the storage enclosure may have a charging panel at each end of the enclosure. Each charging panel may include two or more USB ports. The USB ports 220a and 220b act as ports to charge electronic devices. In some implementations, the maximum output for the USB port is 5 volts and 2.1 Amps. In some implementations, when an electronic device is connected by a USB cord to one of the USB ports, the connected device is charged by the energy stored in the internal battery. The charging panel 216 includes an LED light battery life indicator 224 that displays the battery level of the internal battery to the user. In some implementations, the LED light battery life indicator may blink or otherwise signal to indicate when the battery power is critically low. In some implementations, the battery life indicator may be displayed on an LCD display. The storage enclosure can be used to charge one, two, or more than two different electronic devices at the same time. The storage enclosure may be compatible with one or more different types of electronic devices, for example smartphones, tablets, and electronic readers. The battery may be equipped with battery over voltage protection, battery overcharge protection, and battery over current protection to avoid damage to any electronic devices connected to the USB ports of the storage enclosure. In some implementations, the inner surface of the lower portion 104 may be lined with an electronic charging pad which charges electronic devices placed on the pad without having the electronic devices physically connected to the charging panel.

The lower portion 114 of the storage enclosure includes a connector 116. The connector 116 can be used to connect the storage enclosure to another object. In some implementations, the storage enclosure may be equipped with one or more connectors. As illustrated in FIG. 3, the connector 116 can be used to connect a harness clip 218 to the storage enclosure. The harness clip 118 may be made of a high strength material such as high strength aluminum. The harness clip 218 may be used to connect the storage enclosure to a user's backpack, canoe, raft, fishing box, cooler, or any other suitable object. In some implementations, the storage enclosure may be equipped with a handle. For example, the lower portion may include a handle positioned on the outer surface of the lower portion.

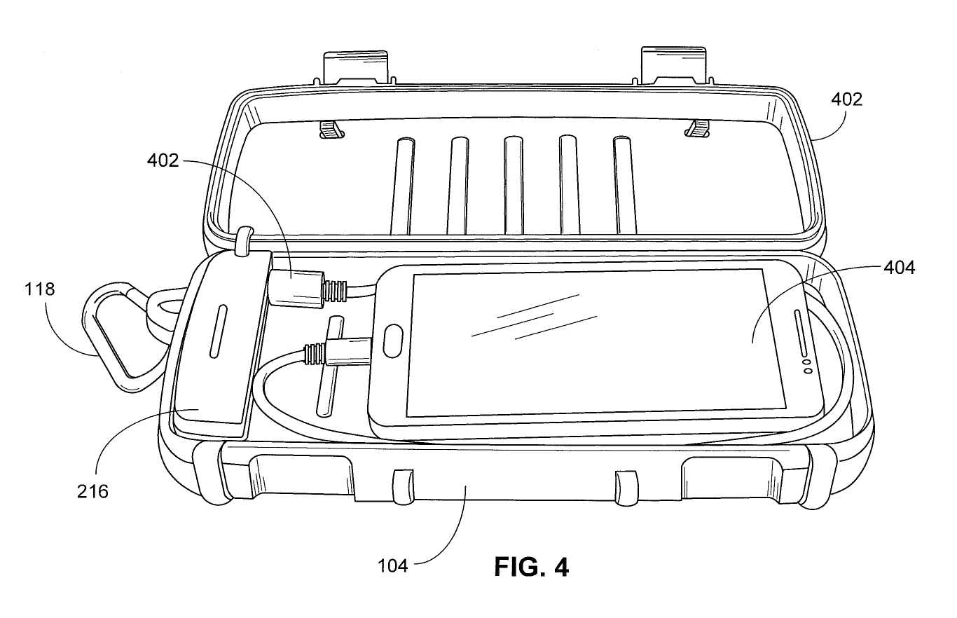

The storage enclosure can be used to store and charge electronic devices. As illustrated in FIG. 4, a smart phone 404 is connected by a USB cord 402 to the charging panel 216. The storage enclosure can be closed with the smart phone 404 in the enclosure. In this configuration the enclosure protects the smart phone while it is being charged by the enclosure. The storage enclosure may be connected, by harness clip 118, to the user's backpack. The user may charge the storage enclosure prior to, during, or after outdoor activity. For example, the user may connect the inlet charging port to a power cord and plug the power cord into a wall socket to charge the internal battery of the enclosure. The user may charge the storage enclosure while the user is outdoors. For example, while the user is camping, the enclosure can absorb solar energy to charge the internal battery of the enclosure. The charged internal battery may then be used to charge the user's electronic devices. Alternatively or additionally, the electronic device can be charged as the internal battery is charged by solar energy.

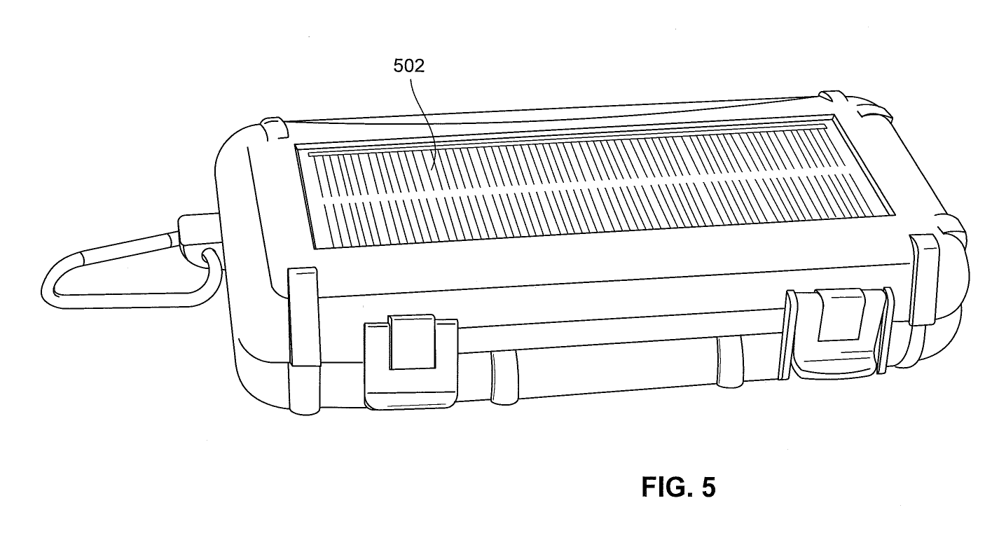

Although in some implementations the outer surface of the storage enclosure may be green in color, as depicted in FIGS. 1-3, any color may be used. The outer surface of the storage enclosure may be provided in multiple different colors and different patterns. For the example illustrated in FIG. 5, the storage enclosure and, in some embodiments, the solar panel may have a camouflage green color. The solar panel mounted to the outer surface of the storage enclosure may be the same color and have the same pattern as the storage enclosure. In some implementations, the storage enclosure may be used as a tackle box. The storage enclosure may be green, or any other suitable color. In these implementations, the storage enclosure may include one or more compartments that may be used to store various equipment used for fishing. In some implementations, the storage enclosure may be sized to fit a tool kit. In some implementations, the storage enclosure may be yellow in color and used by constructions workers. For example, constructions workers may place their tool kit into the storage enclosure while out at construction sites. In some implementations, the outer surfaces of the storage enclosure are marine orange in color, and the solar panel mounted on the storage enclosure is also marine orange in color. The marine orange colored storage enclosure may be used by boaters, kayakers, canoes, and/or fishermen. The storage enclosure may include a strobe light that is activated when exposed to water. The strobe light may be mounted to the outer surface of the lower portion of the storage enclosure and may be electrically connected to the charging panel. When activated either manually or by a pre-selected external trigger, the strobe light emits a visual SOS distress signal. For example, the distress signal may be activated if the storage enclosure falls overboard, or the boat, canoe, or kayak that holds the storage enclosure is turned over. In some implementations the strobe light may be activated when the storage enclosure is immersed in water for a predetermined period of time. For example, the distress signal may be activated when the strobe light is immersed in water for more than two minutes. The distress signal may be used by rescue personnel to locate the storage enclosure and the associated users. The strobe light may have the ability to release a distress signal for extended periods of time to ensure the location and safety of users of the storage enclosure. In some implementations, the distress SOS signal may be activated manually by a user.

In some implementations, the storage enclosure may include one or more speakers. In some implementations the one or more speakers can be used to produce an audible distress signal. For example, a speaker may be connected to the outer surface of the upper portion of the storage enclosure. The speaker may be coated with a clear protective coating. The protective coating may help to waterproof the speaker. In some implementations, the speaker may be coated with a polycarbonate material or an acrylic material. The speaker may be manually activated by a user. The audible distress signal may be used by rescue personnel to locate the storage enclosure and the associated user(s). In some implementations, the speaker can produce an audible stress signal for more than two days. In some implementations, the storage enclosure may produce an audible distress signal if dispersed in water for more than two minutes. In some implementations, the speaker of the storage enclosure may produce an audible signal if the battery life of the internal battery is low. In some implementations, the user may play music or other audio from an electronic device through the one or more speakers of the storage enclosure. A user may connect an electronic device to the storage enclosure by connecting to a USB port on the charging panel to the electronic device and playing the music through the electronic device. For example, a user may play music through a storage enclosure while at the beach. In some implementations the storage enclosure includes both a strobe light and a speaker.

In some implementations, the storage enclosure may include a volume knob mounted on a surface of the storage enclosure, in some implementations on the outer surface of the upper portion of the storage enclosure. The volume knob may be mounted on the outer surface close to the speaker. The volume knob may be used to adjust the volume of the distress signal produced by the speaker. In some implementations, the volume knob may be used to adjust the volume of music played through an electronic device connected to the storage enclosure. The electronic device may be connected to the USB port on the charging panel of the storage enclosure. When the storage enclosure is in a closed position with the electronic device within the enclosure, the volume knob on the outer surface of the enclosure may be used to adjust the volume of the music that is played through the speaker of the storage enclosure.

In some implementations, the storage enclose may include a digital display mounted on a surface of the storage enclosure, in some implementations on an inner or an outer surface of the storage enclosure. The digital display may be coated with a clear protective coating. The protective coating may help to waterproof the digital display. In some implementations, the digital display may be coated with a polycarbonate material or an acrylic material. The digital display may display stored content from an electronic device that is connected to the USB port on the charging panel of the storage enclosure. In some implementations, the digital display may display the stored content from the electronic device connected to the storage disclosure only when the storage enclosure is in a closed position. The digital display may include one or more knobs or buttons that may be used to scroll through and otherwise maneuver through the content on the electronic device. The digital display may include an on/off knob that can be used to switch the display on and off. The digital display may include an option to select to play music from the connected electronic device. The digital display may include a forward and backward selection, a play selection, and a pause selection that may be used to control the music played through the storage enclosure. In some implementations, the digital display may include any other suitable knobs or selections.

In some implementations, where the electronic device connected to the storage enclosure is a smart phone, the digital display may display the contact information for an incoming call received on the smart phone. In some implementations, the storage enclosure may display the contact information only when an incoming call is received when the enclosure is in a closed position. The digital display may include a selection that allows a user to answer or decline the incoming call. When a user decides to answer an incoming call the user may communicate with the caller through the speaker mounted to the outer surface of the storage enclosure. The digital display may also include a selection to end the call. For example, when the user is out fishing or canoeing and has his/her smart phone stored in the storage enclosure to protect the phone from being wet, the user may still receive calls. In some implementations, the digital display may include knobs or selections that allows a user to scroll through the contacts stored on a smart phone connected to the storage enclosure. The user may scroll through the contacts and make a selection to make an outgoing call when the storage enclosure is in a closed position. In some implementations, the digital display may display the contents of an incoming text message or email message.

In some implementations, the storage enclosure may include Bluetooth capability. In these implementations, Bluetooth capable electronic devices may pair with the storage enclosure. In these implementations, a user may have the ability to make outgoing calls and answer incoming calls using voice commands. For example, a user may store a Bluetooth capable cellular phone within the storage enclosure, and may answer an incoming call by speaking into the speaker mounted on the outer surface of the storage device. The user may also make outgoing calls, when the cellular phone is stored within the enclosure. For example, the user may use the voice activated option when the user is at the pool or on the beach and has his/her cellular phone stored within the enclosure to protect the phone from being wet.

In some implementations, the storage enclosure may act as a Wi-Fi hotspot. For example, the storage enclosure may be a wireless router that can provide internet access to nearby Wi-Fi enabled electronic devices. In some implementations the storage enclosure may be equipped with GPS technology. In some implementations, the user may locate a storage enclosure that acts as a Wi-Fi hotspot by using a location detector application on the user's smart phone. In some implementations, the GPS location of the storage enclosure may be tracked by a mobile application. In some implementations, the mobile application may be used to locate missing persons.

In some implementations, the charging panel in the storage enclosure may include one or more charging ports for other electronic devices. For example, the storage enclosure may include a charging port for a GoPro® camera. In some implementations, the storage enclosure may include one or more waterproof speakers. The waterproof speakers may be used to play music or other content from the user's electronic device that is connected to the charging port of the storage enclosure.

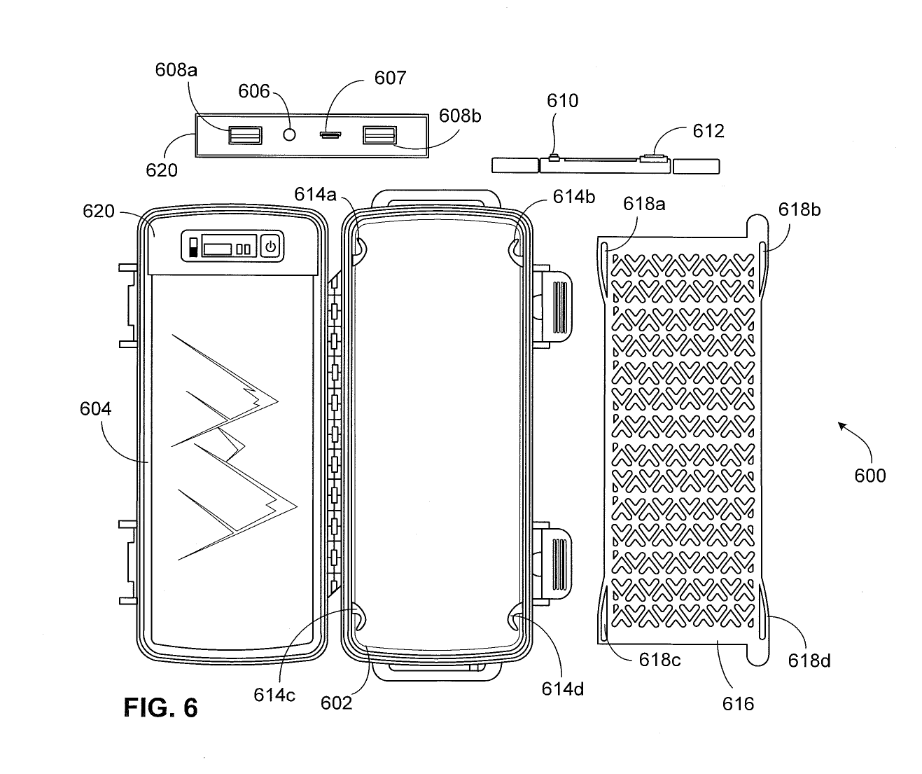

As illustrated in FIG. 6, the storage enclosure 600 includes an upper portion 602 and a lower portion 604. The upper portion 602 and the lower portion 604 may be made from an injection molded polycarbonate material. The polycarbonate material ensures that the storage enclosure 600 is durable, shock-proof, and fairly light weight. In some examples, the storage enclosure may weigh less than two pounds, for example, 1.75 lbs. In some implementations, the upper portion 602 and lower portion 604 may be made from a carbon nanotube material, a polyester material, a high-density polyethylene (HDPE) material, or an acrylic material. In some implementations, the upper portion 602 and lower portion 604 are made from the same material. In some examples, the storage enclosure 100 may be a floatable enclosure. The storage enclosure may be waterproof, dust proof, and drop proof.

The lower portion 604 of the storage enclosure 600 includes a charging panel 620. The charging panel 620 is positioned at one end of the recessed inner surface of the lower portion 604. The charging panel 620 may be coated with a nano-coating to prevent the corrosion of the charging ports or to prevent physical damage to the components. The charging panel 620 includes two smart USB ports 608a and 608b and an inlet charging port 607. In some implementations, the USB charging ports 608a and 608b may be mounted at an eight degree angle to increase the ease of use. The inlet charging port 607 is used to charge the internal battery by connecting one end of a power cord to the inlet and the other end to a wall outlet or car charger, or any other suitable power source. In some implementations, the internal battery may be fully charged via the USB port within six hours. In some implementations, the storage enclosure may have a charging panel at each end of the enclosure. Each charging panel may include two or more USB ports. The USB ports 608a and 608b act as ports to charge electronic devices. In some implementations, the maximum output for the USB port is 5 volts and 2.1 Amps. In some implementations, when an electronic device is connected by a USB cord to one of the USB ports, the connected device is charged by the energy stored in the internal battery. The charging panel 620 includes an LCD display. The storage enclosure can be used to charge one, two, or more than two different electronic devices at the same time. The storage enclosure may be compatible with one or more different types of electronic devices, for example smartphones, tablets, and electronic readers. The battery may be equipped with battery over voltage protection, battery overcharge protection, and battery over current protection to avoid damage to any electronic devices connected to the USB ports of the storage enclosure. In some implementations, the inner surface of the lower portion 604 may be lined with an electronic charging pad which charges electronic devices placed on the pad without having the electronic devices physically connected to the charging panel.

In some implementations, the LCD display may display the battery life of the internal battery to the user. In some implementations, the LCD display may be equipped to display the detected altitude. In these implementations, the storage enclosure may be equipped with a barometer to measure altitude. This feature may be useful for users that hike with the storage enclosure. In some implementations, the barometer may be used to detect weather conditions, the updated weather conditions may be displayed on the LCD display. In some implementations, the speakers may generate an audio alert when there is a sudden decrease in air pressure. In these implementations, the external LED may flash to indicate the decrease in air pressure. In some implementations, the storage enclosure may be equipped to detect a level of static charge. The static charge level detecting capability may be used as a warning of the potential risk of lightning. In these implementations, the speakers may generate an audio alert when a risk for lightning is detected. In some implementations, the storage enclosure may be equipped with a compass. In these implementations, the compass may be used by hikers, or boaters for navigation. The LCD display may be used to display the compass points. In some implementations, the storage enclosure may be capable of detecting frequencies that can be used to detect an avalanche.

The inner surfaces of the upper portion 602 and the lower portion 604 may be recessed to form an area to store items. For example, a user can store small electronic items such as an iPod, smart phone, or may store personal documents such as, an identification card, or a passport. In some implementations, the storage enclosure may be a rectangular enclosure that measures about 9×4 inches. In some implementations, the shape and size of the enclosure may vary. The storage enclosure may generally be of any shape, including, without limitation, cylindrical, cuboid, or circular. The recessed area of the upper portion 602 and the lower portion 604 is each lined with a silicone tray. The silicone tray may be textured to prevent items stored in the storage enclosure from moving around. The silicone tray may be soft to protect electronic devices stored within the enclosure from damage. In some implementations, the silicone trays may be removable. In some implementations, the recessed area of both the upper portion and the lower portion are each lined with a polymer material.

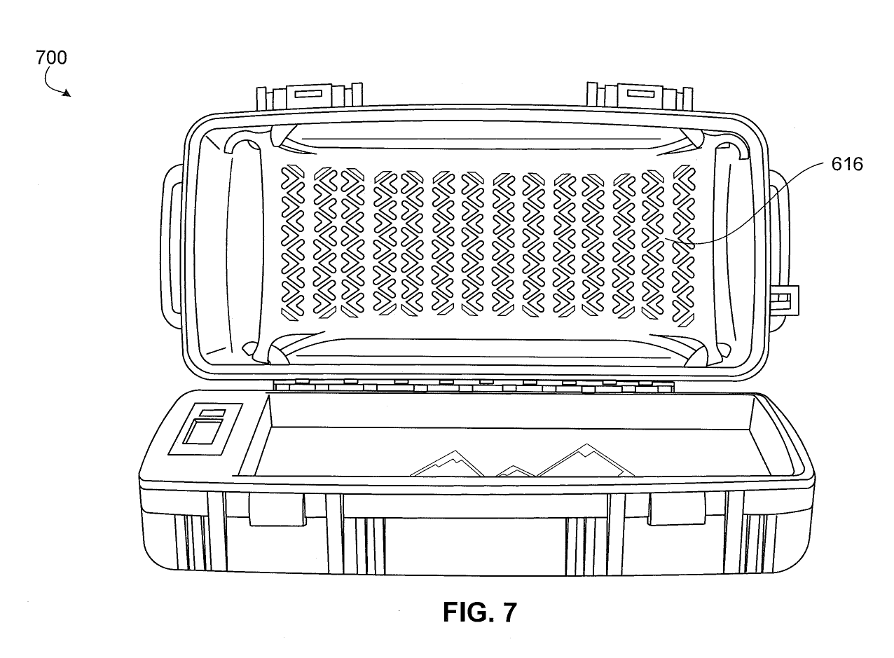

In some implementations, each of the four corners of the upper portion 602 includes a hook shaped fastener 614a to 614d. The hook shaped fasteners 614a to 614d may be positioned to align with each of the four corners 618a to 618d of a removable netting 616. As illustrated in FIG. 7, the removable netting 616 may be attached to the inner side of the upper portion 602 by hooking each of the four corners 618a to 618d of the removable netting to each of the hook shaped fasteners 614a to 614d. The removable netting may be used to secure items in the recessed area of the upper portion 602 of the storage enclosure 600. The removable netting 616 may be made of a flexible material. In some implementations, the removable netting may be composed of silicone, or a plaster polymer.

1. A storage enclosure comprising:
a first portion with a recessed inner surface;
a complementary second portion with a recessed inner surface, coupled to the first portion, wherein a first end of the second portion is hinged to a first end of the first portion, and wherein a resealable opening extends along a second end of the second portion and a second end of the first portion;
a solar panel mounted to an outer surface of the first portion;
a charging panel within the storage enclosure, wherein the charging panel is mounted to the inner recessed surface of the second portion, and is electrically connected to the solar panel and an internal battery; and
a light mounted on an outer surface of the second portion and electrically connected to the charging panel.

2. The storage enclosure of claim 1 wherein the light is an LED light.

3. The storage enclosure of claim 1 wherein the light is a water activated strobe light.

4. The storage enclosure of claim 3 wherein the strobe light emits a distress signal when activated.

5. The storage enclosure of claim 1 wherein the storage enclosure is water-proof.

6. The storage enclosure of claim 1 wherein the storage enclosure is shock-proof.

7. The storage enclosure of claim 1 wherein the storage enclosure is dust-proof.

8. The storage enclosure of claim 1 wherein the storage enclosure is fire-proof.

9. The storage enclosure of claim 1 wherein the resealable opening is held in a closed position by a locking mechanism.

10. The storage enclosure of claim 1 wherein a second solar panel is mounted to the outer surface of the second portion.

11. The storage enclosure of claim 1 where the charging panel includes one or more USB charging ports.

12. The storage enclosure of claim 1 wherein the inner recessed surface of the second portion is lined with a charging pad.

13. The storage enclosure of claim 1 wherein the inner recessed surfaces of the first and second portions are lined with silicone.

14. The storage enclosure of claim 1 wherein the charging panel includes an LCD screen that indicates a level of battery power.

15. The storage enclosure of claim 1 wherein the enclosure further comprises a connector that connects to a harness clip.

16. The storage enclosure of claim 1 wherein the storage enclosure is sized to store a smart phone.

17. The storage enclosure of claim 1 wherein the storage enclosure is sized to store a tool kit.

18. The storage enclosure of claim 1 wherein the inner recessed surface of the first portion includes one or more Velcro straps.

19. The storage enclosure of claim 1 wherein the inner recessed surface of the first portion includes a removable netting.
